(19) United States
(12) Patent Application Publication
(10) Pub. No.: US 2005/0130629 A1
(43) Pub. Date: Jun. 16, 2005

(54) Message management in wireless communications devices and methods

(76) Inventors: Uday R. Kelkar, Grayslake, IL (US); Amit K. Shah, Lindenhurst, IL (US)

Correspondence Address: MOTOROLA INC, 600 NORTH US HIGHWAY 45, ROOM AS437, LIBERTYVILLE, IL, 60048-5343, US

(21) Appl. No.: 10/732,121

(22) Filed: Dec. 10, 2003

(51) Int. Cl. H04Q 7/20

(52) U.S. Cl. 455/412.1; 455/422.1

(57) ABSTRACT

A method in a messaging service subscriber device including a removable smart card having information particular to a user of the messaging service subscriber device, for example, a GSM subscriber device having a subscriber identification module (SIM). The method includes receiving (230) a message via the messaging service, evaluating (240) the message received relative to a message profile stored on the smart card, and disposing (250, 260) of the message received based on the evaluation of the message received relative to the message profile stored on the removable smart card.

### FIELD OF THE DISCLOSURE

The present disclosure relates generally to messaging in communications devices, and more particularly to message management in messaging service subscriber devices, for example, in wireless cellular communications devices, some of which include removable subscriber identification modules, and corresponding methods in messaging service subscriber devices.

### BACKGROUND OF THE DISCLOSURE

Users of mobile station messaging services including, for example, Short Message Service (SMS), Enhanced Messaging Service (EMS), and Multimedia Messaging Service (MMS) in Public Land Mobile Networks (PLMNs), and in other communications networks, have grown substantially. Messaging services subscriptions generally are expected to continue to grow within and beyond the wireless communications environments.

Messaging has substantial appeal as a marketing tool and revenue generator. A drawback of messaging service based marketing however is that messaging service subscribers are sometimes unreceptive to receiving unsolicited messages, which are considered by some subscribers to be inconvenient and annoying. Service providers are sensitive to subscriber concerns and may be reluctant to exploit messaging based marketing absent sufficient subscriber safeguards.

Some messaging practices, for example, bulk and broadcast messaging, have the potential to substantially burden limited service provider network resources, for example, cable and wireless radio spectrum bandwidth. US2002/0168978 A1 entitled “Method For the Restriction of a Message Service” discloses restricting short messaging services messages in communication networks by keeping a record, in a network mobile switching center, i.e., a visited switching center or in an internetworking switching center, containing information about certain addresses to which messages are not allowed to be sent. US2002/0168978 prevents the transmission of messages to addresses to which message transmission is not allowed based on the record kept. The US2002/0168978 purports to save switch capacity, link capacity and message service center capacity.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary communications network in which messaging services are provided to messaging service subscriber devices.

FIG. 2 is an exemplary process flow diagram for evaluating messages either at a messaging service subscriber device or at a messaging server.

### DETAILED DESCRIPTION

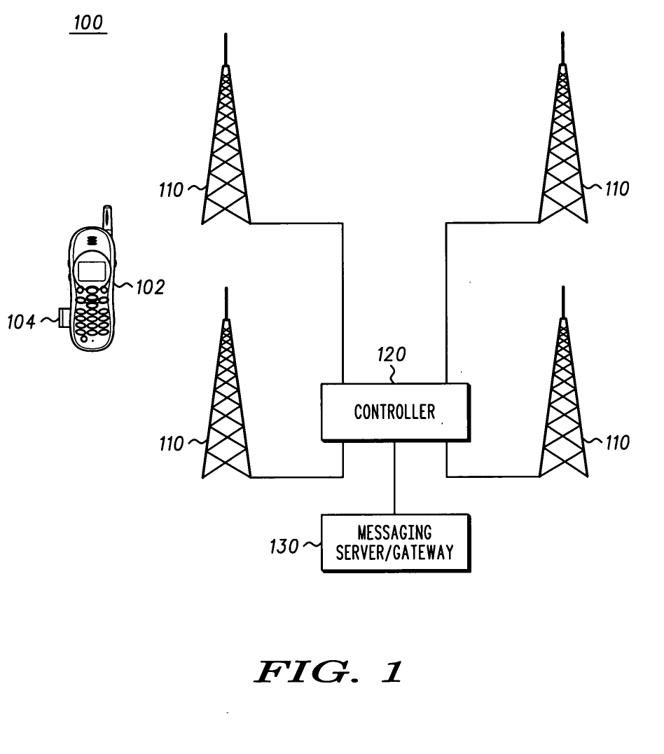

FIG. 1 is an exemplary wireless communications network 100 capable of providing messaging services to messaging service subscriber devices, for example, to wireless mobile communications station 102. The exemplary wireless communications network is a cellular network including access and core network infrastructure portions. The exemplary access network infrastructure comprises a plurality of base stations 110, for example, multiple Global System for Mobile Communications (GSM) base transceiver stations (BTS), communicably coupled to a controller 120, for example, to a GSM base station controller (BSC). In one embodiment, the core network portion includes location registers, a switching center, for example, a GSM Mobile Switching Center (MSC), and/or a packet data network gateway or node, for example, a Serving GPRS Support Node (SGSN), known generally in wireless network infrastructure architectures but not illustrated. In other embodiments, the communications network supports CDMA, 3^{rd} Generation Partnership Project (3GPP) Universal Mobile Telephone System (UMTS) W-CDMA, IEEE 802.11, TCP/IP, among other communications protocols, including wire-line protocols.

The exemplary network also includes a messaging server/and or a messaging gateway 140 communicably coupled to the controller 120. In some embodiments, the messaging server/gateway is also coupled to a mobile switching center and/or to a packet server/gateway. The messaging server may support, for example, Short Message Service (SMS) protocol, Enhanced Messaging Service (EMS) protocol, Multimedia Messaging Service (MMS) protocol, among other messaging protocols. In the exemplary embodiment, messages are communicated to messaging service subscriber devices, for example, mobile station 102, via the messaging server/gateway in the exemplary wireless or other communications network.

In FIG. 1, the exemplary messaging service subscriber device is a wireless communications device, for example, a cellular telephone handset, or a personal digital assistant (PDA), or a wireless enabled laptop or notebook computer, etc. In other embodiments, the messaging service subscriber device may not be a mobile or wireless device. The subscriber device may be a fixed wireless or wire-line station, for example, a computer or browsing device coupled to the Internet or some other network by a physical cable or a Wireless Fidelity (WIFI) network connection.

In one embodiment, the messaging service subscriber device includes a removable smart card having information, for example, unique identification information, specific to a user of the messaging service subscriber device. The smart card may also enable the user to customize the device into which the card is inserted. In the exemplary embodiment of FIG. 1, the messaging service subscriber device 102 includes a smart card 104, for example, a GSM Subscriber Identification Module (SIM), or a Universal Subscription Identity Module (USIM), or some other removable module on which user specific information is stored. The exemplary SIM and USIM removable devices include tool kit applications, e.g., the SIM Toolkit Application, with commands that permit the card to initiate actions and perform operations or request information, etc.

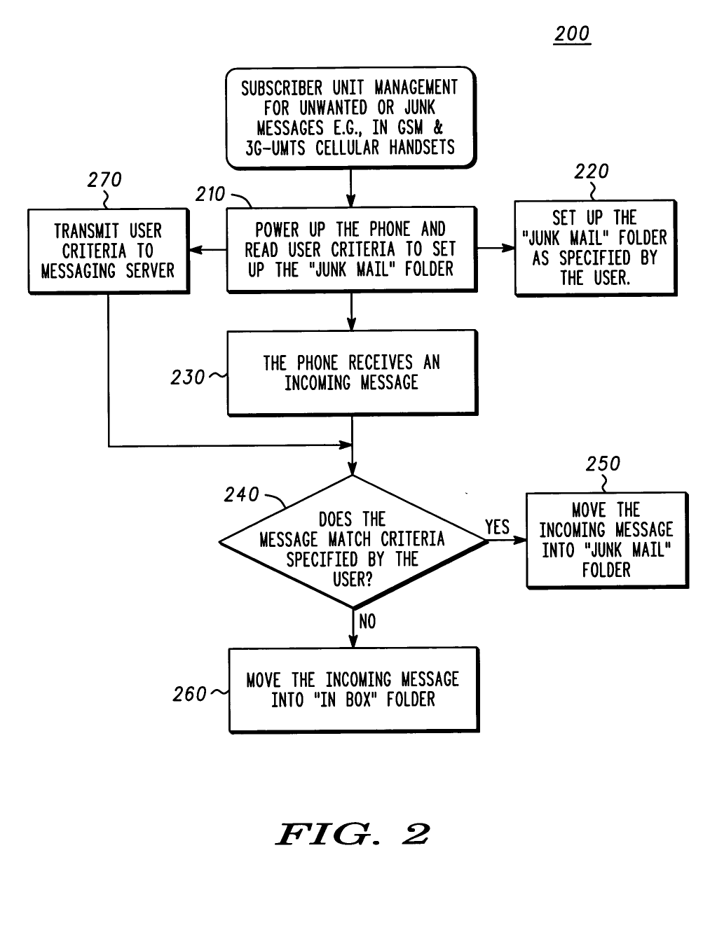

In the exemplary process diagram 200 of FIG. 2, at block 210, a messaging service subscriber device is powered-up and the device reads one or more user established criterion, for example, in the form of a message profile, by which the subscriber device will evaluate messages received. In one embodiment, the one or more criterion or profile is stored on a smart card of the subscriber device. In one embodiment, the profile or criteria are defined using a smart card tool kit application, for example, a SIM Toolkit Application. In an alternative embodiment, the one or more criterion or the profile is stored in location other than a smart card, for example, stored in non-volatile memory of the subscriber device.

In FIG. 2, at block 220, the subscriber device sets up any folders, for example, a junk mail folder, a recycle bin, in-box, etc., as desired by the user consistent with the one or more criterion or profile read at block 210. In one embodiment, this functionality is performed by an application on a smart card of the subscriber device, for example, by a SIM Toolkit Application. Alternatively, an application performing these tasks may reside at some other location on the subscriber device, for example, in non-volatile memory.

In FIG. 2, at block 230, the messaging service subscriber device receives a message via the messaging server/gateway, for example, via the exemplary wireless infrastructure of FIG. 1. In one embodiment, all messaging service subscriber device terminated point-to-point and or broadcast messages generate a notification to an application on the subscriber device, for example, on a smart card or in non-volatile memory, via envelope download. As noted, in some embodiments, this application is developed using a smart card tool kit application. In one embodiment, the criteria or profile and the application are both stored on the smart card, and in another embodiment the one or the other is stored on the smart card and the other is stored in a location other than the smart card.

At block 240, the application compares the message relative to the predefined profile or criteria, as discussed further below, specified at block 210. In one embodiment, the application on the subscriber device determines whether the received message satisfies a condition based upon at least one criterion other than an address of a sender of the message received. In other embodiments, the message received is evaluated by comparing the message relative to at least one of an identification of a sender of the message received, a class of the message received, and a type of the message received. As noted, in at least one embodiment, the application and/or the criteria or profile are stored on a smart card of the messaging services subscriber device.

The messaging service subscriber device disposes of the messages received based on the evaluation of the messages. In FIG. 2, at block 250, for example, the message falls under the unwanted or junk mail category set by the user, then the application directs the storage of the message in a “Junk Mail Folder” or some other appropriate receptacle. The user can later manage the “Junk Mail” folder at a convenient time. In other embodiments, messages may be quarantined or deleted automatically, for example, by locating unwanted messages in a recycle bin or immediately purging the messages. At block 260, desired messages are moved into an “inbox” or they are stored at some other designated location.

In another embodiment, in FIG. 2, at block 270, the messaging service subscriber device communicates its criteria or profile information to the network, for example, to the messaging server in its home network. According to this alternative embodiment, the messaging server performs the evaluation of messages addressed to the messaging service subscriber device before the messages are sent to the subscriber device. In FIG. 2, message evaluation by the messaging server occurs at block 240. In one embodiment, the messaging server determines whether the received message satisfies a condition based upon at least one criterion other than an address of a sender of the message received. In other embodiments, the messaging server evaluates the message by comparing the subject message relative to at least one of an identification of a sender of the message received, a class of the message received, and a type of the message received. In some embodiments, unwanted messages are disposed, e.g., purged, at the messaging server without transmission of the messages to the subscriber, thereby reducing unnecessary allocation of network resources to the delivery of unwanted messages. Thus in some embodiments, at block 250 of FIG. 2, rather than place unwanted messages in a junk mail folder at the subscriber device or at the messaging server, the messaging server may delete messages unwanted by the addressee. In other embodiments, the messaging server may flag unwanted messages for the recipient subscriber device, which may then dispose of the messages appropriately, for example, by placing flagged messages in a recycle bin or a designated inbox. In FIG. 2, at block 260, the messaging server forwards desirable messages to the addressee subscriber device, which may then place the desirable messages in an “in box” upon receipt.

While the present disclosure and the best modes thereof have been described in a manner establishing possession by the inventors and enabling those of ordinary skill to make and use the same, it will be understood and appreciated that there are equivalents to the exemplary embodiments disclosed herein and that modifications and variations may be made thereto without departing from the scope and spirit of the disclosure, which is to be limited not by the exemplary embodiments but by the appended claims.

1. A method in a wireless communications device including a removable module specific to a user of the wireless communications device, the method comprising:
receiving a message;
evaluating the message received relative to message profile information stored on the removable module;
disposing of the message received based on the evaluation of the message received relative to the message profile information stored on the removable module.

2. The method of claim 1,
evaluating the message received relative to message profile information stored on the removable module includes determining whether the message satisfies a condition;
disposing of the message received based on determining whether the message received satisfies the condition.

3. The method of claim 1, evaluating the message received relative to the message profile information stored on the removable module includes comparing the message received relative to at least one of an identification of a sender of the message received, a class of the message received, and a type of the message received.

4. The method of claim 1,
disposing of the message received includes storing the message received in a folder based on the evaluation of the message received relative to the message profile information stored on the removable module.

5. The method of claim 4, storing the message received in one of a junk mail folder and recycle bin if the message received is unwanted.

6. The method of claim 1, notifying an application upon receipt of the message, evaluating the message relative to message profile information using the application after notifying.

7. The method of claim 1, communicating profile information from the removable module of the wireless communications device to a network.

8. The method of claim 1, the removable module is an identification module, evaluating the message received relative to message profile information stored on the identification module.

9. The method of claim 1, evaluating the message received relative to message profile information using an application stored on the removable module.

10. A method in a messaging service subscriber device, the method comprising:
receiving a message;
determining, at the messaging service subscriber device, whether the message received satisfies a condition based upon at least one criterion other than an address of a sender of the message;
disposing of the message received based on whether the message received satisfies the condition.

11. The method of claim 10,
disposing of the message received includes storing the message in one of a plurality of locations based on whether the message received satisfies the condition.

12. The method of claim 10,
disposing of the message received includes storing the message in one of a message inbox, an unwanted message folder, and a recycle bin based on whether the message received satisfies the condition.

13. The method of claim 10,
the at least one criterion is stored on a removable identification module of the messaging service subscriber device,
determining whether the message received satisfies the condition based using the at least one criterion and an application stored on the removable identification module of the messaging service subscriber device.

14. A method in a messaging service subscriber device including a removable smart card having information particular to a user of the messaging service subscriber device, the method comprising:
receiving a message via the messaging service;
evaluating the message received relative to a message profile stored on the smart card;
disposing of the message received based on the evaluation of the message received relative to the message profile stored on the removable smart card.

15. The method of claim 14, evaluating the message includes determining, at the messaging service subscriber device, whether the message received satisfies a condition based upon at least one criterion other than an address of a sender of the message.

16. The method of claim 14, evaluating the message includes comparing the message received relative to at least one of an identification of a sender of the message received, a class of the message received, and a type of the message received.

17. The method of claim 14, evaluating the message received relative to a message profile using an application stored on the smart card.
